(19) United States
(12) Patent Application Publication
(10) Pub. No.: US 2005/0051965 A1
(43) Pub. Date: Mar. 10, 2005

(54) Apparatus and method for a card dispensing system

(76) Inventor: Prem Gururajan, Kitchener (CA)

Correspondence Address: Gowling Lafleur Henderson LLP, Suite 4900, Commerce Court West, Toronto, ON, M5L 1J3, CA

(21) Appl. No.: 10/876,620

(22) Filed: Jun. 28, 2004

Related U.S. Application Data
(60) Provisional application No. 60/482,493, filed on Jun. 26, 2003.
(60) Provisional application No. 60/534,986, filed on Jan. 9, 2004.

(51) Int. Cl. A63F 13/00

(52) U.S. Cl. 273/292

(57) ABSTRACT

A system automatically monitors playing of a game and gathers data in real time. An overhead imaging system automatically images the game table and provides an overhead view of the game table and/or the dealer's chip tray. A lateral imaging system images the gaming area, especially the wagering regions, to provide a lateral view of the chips on the table. An automatic card shoe system dispenses cards and automatically images at least one card immediately prior to its withdrawal from the shoe. A positioning module processes images from the overhead imaging system to automatically track the position of gaming objects such as for example playing cards, chips, currency bills on the gaming table. An identity module processes images from the overhead imaging system to automatically track the identity of gaming objects on the gaming table. A chip identity module processes overhead images of the chip tray and lateral images of the gaming region to automatically determine, the identity and position of gaming chips. A card-shoe software associated with the automatic card shoe system processes signals from the automatic card shoe system to automatically identify the game related value of at least one card immediately prior to its withdrawal from the shoe by a dealer.

### FIELD OF THE INVENTION

The present invention relates to a card dispensing system for table games in casinos.

### BACKGROUND OF THE INVENTION

Casinos and other forms of gaming are popular forms of entertainment. Table games such as blackjack and baccarat are a significant portion of a casino's offered games. Typically, in table games, a human game operator at the table, such as a dealer, performs activities in concurrence with the rules of the game, such as dealing cards, making decisions about the game outcome, collecting and giving out chips, and other actions relevant to the flow of the game. The odds of each game slightly favor the casino and on average the casino wins and is profitable.

The profitability of a casino is directly dependent on three critical factors: Customer Service, Operations Efficiency and Security. Hence, a casino will spend millions of dollars annually to monitor and manage these three factors.

Casinos have a compensation (comp) program to reward their valuable players. This is a part of their marketing system to attract high spending players. In order to identify valuable players, casinos profile their customers—they monitor how much a player spends, how much the player wins/loses and how long the player plays. This player profiling or monitoring is done manually. Trained supervisors observe a player's game play and manually key in the observed and estimated data. Manual monitoring is limited and inaccurate. Casino managers want a system that will automate player profiling, improve the accuracy of player profiling and lower the labor costs associated with player profiling.

Casinos constantly monitor the profitability of their table games to ensure that the tables are being operated efficiently. Among other aspects, they monitor hands-dealt-per-hour, dealer errors and total amount wagered. These efficiency reports allow them to understand their operations and organize their structure for maximum efficiency. This monitoring also allows casinos to spot dealer errors, a significant problem in casinos. At present, these efficiency measures and errors are manually monitored and estimated. A subset of monitored data is generalized to all tables. Casino directors have a strong need for comprehensive efficiency reports and a need to instantly identify and rectify dealer errors. Currently this is unaffordable due to the high labor costs associated with monitoring and gathering such data. Casino managers have a need for a system that automates efficiency monitoring and provides comprehensive data reporting.

A large casino can lose a significant amount of money due to cheating each year. Some usual forms of cheating include card counting and collusion between dealers and players. Casinos have hired trained employees to manually monitor tables to catch card counters and fraudulent dealers. The labor costs to do this are high and since it is manually done, many forms of cheating go unnoticed or are caught too late. Casinos want to be able to quickly identify cheaters or fraudulent dealers. Casino managers want a system that can automatically track transactions and the game play of players and identify procedure violations or fraud in real time.

Casinos keep track of the chips in their dealer's chip trays by manual counting. Chip tray inventory is currently a manual process. Casinos can save significant labor and improve accuracy of inventory tracking if they have an apparatus that can automatically keep track of the chips in the dealer's chip tray.

New types of table games are invented often and casinos modify existing table games to make them more exciting for gaming customers. Slot machines have become immensely popular since the concept of progressive winning has been introduced. In this form of gaming, the slot machines are connected. This allows a player at one slot machine to win the combined earnings of many of the connected machines, thus making the upper limit for an individual winning higher. Casinos have made attempts to introduce the concept of progressive winnings to table games. One of the obstacles facing casinos is that the outcomes of the games at the different tables have to be automatically obtained in real-time to enable progressive gaming with table games.

Online table gaming is a new form of gaming that is growing in popularity. Online gaming companies wish to have a tracking system that can record the physical activities happening in a live casino setting in digital format. This would enable the online gaming company to build online table games that would allow remote players to play on a real live game table.

### DESCRIPTION OF THE RELATED ART

A game monitoring system being developed and sold by MindPlay LLC and as described in the family of U.S. patents to Soltys et al. seeks to solve some of the issues that have been mentioned in the background information. The shortcoming of the Mindplay system is that when a chip tray is used to house the table monitoring apparatus, numerous cameras need to be placed to obtain a complete view of the gaming table. Moreover, installing cameras in the chip tray require significant modifications to the game table and chip tray, which some casinos may find undesirable. Installing cameras under the chip tray also alters the gaming experience of the players because cameras are visibly and directly in front of the players. Playing on an altered table does not provide players an authentic table game experience. The card shoe device utilized by the MP21 system sold by Mindplay requires the use of playing cards with specially printed machine readable code or barcode. Barcoded cards are more expensive compared to normal playing cards and casinos might find this undesirable, especially since playing cards are a recurring cost. The disclosed Mindplay card shoe implementatino does not utilize normal playing cards without barcodes. The card shoe reader employed by the Mindplay system can involve reading each of the playing cards in a deck before a first card is dealt. Reading a deck of cards or a sequence of cards before a first card is dealt is disadvantageous because if one card in the play of the game is discarded due to mishandling or any other reason, the sequence of cards becomes offset, potentially causing problems for a tracking system that has already memorized the sequence of cards. Also, some casinos might not accept having a deck of cards pre-scanned because knowing the order of cards removes the element of chance in card games. The method employed by Mindplay to read the chips in the chip tray requires the use of a special chip tray with embedded imaging apparatus and moving mechanical parts.

The card readers embodied in U.S. Pat. Nos. 5,374,061 to Albrecht, 5,941,769 to Order, 6,039,650 to Hill, 6,126,166 to Lorson show embodiments of a card dispensing shoe with means to read or image or scan a playing card as it is being drawn from the shoe. A problem with these systems is that they require imaging or scanning a card being dispensed while it is in motion. The process of scanning or imaging a card while it is in motion requires a high frame rate imager or high scan rate scanner. High speed imagers or scanners can be more expensive and/or larger in size. Further, the process of scanning while a card is in motion can decrease the read accuracy since the image acquired might involve a skew or rotation of the card, potentially causing inaccurate optical character recognition. The Lorson patent describes a system to scan cards using non-imaging light sensors. This embodiment utilizes the sensing of dark pips on cards, and can detect the number with respect to table games where face cards such as Jack and Queen have the same value for the game. It cannot detect the exact rank and suite of a playing card.

U.S. Pat. Nos. 5,782,647 to Fishbine et al.; 5,103,081 to Fisher et al; 5,548,110 to Storch et al.; and 4,814,589 to Storch et al. disclose systems for encoding information on chips and for determining information encoded in the color, geometry, size or patterns on a chip. They do not disclose a methodology to identify and track normal casino chips used in the play of a game. The chip recognition methodology disclosed in U.S. Pat. No. 5,781,647 to Fishbine discusses a method to detect the chips in a stack by identifying edges for each chip in the stack. A problem with this method can be that due to lighting issues, chip edges may not always be clearly identifiable by software means. U.S. Pat. No. 6,532,297 to Lindquist discloses a methodology to extract a horizontal upper and lower edge for chips in a stack. Potential problems with this method can be the same as that in the patent to Fishbine. U.S. Pat. No. 6,688,979 to Soltys, et al. discloses a method of detecting chips in a region of interest by detecting color changes along a row when scanning along the row horizontally. This action is performed for each row. The shortcoming of this method can be that it assumes that the view of the chips is perfectly lateral. This method can potentially fail when the view of the chips is angular because the chip segments' upper and lower edges might not appear horizontal from such an angular view.

The chip tray tracking system disclosed in U.S. Pat. Nos. 5,757,876 to Dam, et al., and 5,742,656 to Mikulak, et al., involve using an ultrasonic transducer in combination with a color sensor to detect the number and type of chips in each column of a chip tray. A problem with ultrasonic transducers can be that their distance measurements can be relatively inaccurate compared to optical distance measuring devices. The chip tray tracking system disclosed in U.S. Pat. No. 5,755,618 to Mothwurf, et al., describes the use of position sensors for each chip location. A shortcoming of this method can be that chips are not always properly stacked and are sometimes slightly positioned at an angle, thus covering more than one chip location. Further, this method does not provide means to identify the exact denomination of each individual chip being sensed. The chip tray tracking system disclosed in the family of U.S. patents to Soltys, et al. discloses a device with imaging apparatus under each chip tray well. This requires the use of a specially built chip tray. None of these prior systems disclose a method for the use of an overhead image of the chip tray combined with image processing to identify chips in the chip tray.

The recognition system disclosed in U.S. Pat. No. 4,531,187 to Uhland, describes a method to determine the value of a card relating to a game of Blackjack. The algorithm utilizes an overhead view and a blob tracking method to count the number of pips visible on a card. The disclosed method does not enable identification of the exact rank and suite of playing cards on the table.

The playing card recognition project developed by a group of students from Rice University, as described in their web-site http://www.owlnet.rice.edu/˜rwagner/play.html is for a laboratory setting with images of cards imaged using a scanner with a constant black background. Their method does not track multiple hands on a real game table. Their method does not automatically track gaming objects on a game table in real time. Their system does not monitor game play in a casino table game environment.

It is an object of the present invention to provide a game tracking system to obviate or mitigate at least some of the above presented disadvantages.

### SUMMARY OF THE INVENTION

In one aspect, an automatic card shoe apparatus for generating an identity signal indicative of the identity of a playing card selected from a stack of playing cards, the apparatus comprising: a base; a compartment coupled to the base for receiving the stack of playing cards; an actuated mechanism coupled to the compartment for offsetting at least one of the playing cards from the stack of playing cards, the actuated mechanism configured for placing the offset card such that the offset card is retained in an offset stationary position with respect to the card stack; a position sensor coupled to the actuated mechanism for sensing the presence of the offset stationary card; and a reader for recording a machine readable indicia positioned on the offset portion of the offset card, the recorded machine readable indicia for use in generating the identity signal.

In a further aspect a method for generating an identity signal indicative of the identity of a playing card selected from a stack of playing cards, the method comprising the steps of: offsetting at least one playing card from a stack of playing cards by an actuated mechanism such that the offset card is retained in an offset stationary position with respect to the card stack; recording a machine readable indicia positioned on the offset portion of the offset card; and generating the identity signal using the recorded machine readable indicia.

The invention can includes a system, apparatus and methods to automatically monitor the activities happening at a gaming table, gather data on game events, provide any necessary feedback or alerts and perform reporting activities.

In one aspect, the invention can include an overhead imaging system that periodically images a gaming table from an overhead view. The overhead imaging system can include one or more individual imagers that periodically image from an overhead perspective, specific regions of the game table such as playing area, wagering area and dealer's chip tray.

In another aspect, the invention can include a lateral imaging system that periodically images the gaming table from a lateral view so as to provide a side view of chips or stacks of chips in the playing area and specifically a wagering area. The lateral imaging system can include one or more individual imagers that periodically image specific regions of the game table such as the wagering regions. Images from the overhead and lateral imaging systems are transmitted to other software modules.

In a further aspect, the invention can include an automatic card shoe system that dispenses cards such that at least one of the foremost cards about to be dealt is positioned staggered with respect to the rest of the deck. The automatic card shoe system includes an imager to image at least one stationary card immediately prior to its withdrawal from the shoe. Images from the automatic card shoe system are transmitted to a software module for processing the images.

In yet another aspect, the invention can include a positioning module that processes images from the overhead imaging system, recognizes gaming objects in a gaming region on a game table and assigns a position indicator to each gaming object. Examples of gaming objects include playing cards, chips and currency bills.

In another aspect, the invention can include an identity module that determines and assigns a game related identity to each recognized gaming object in the gaming region.

The detected position indicator and identity of a gaming object can be termed as the current gaming profile of the gaming object. Data relating to the tracked objects can be transmitted to other software modules.

In a further aspect, the invention can include a chip identity module that processes images from the lateral imaging system and overhead imaging system to identify chips in the gaming area such as chips being wagered by players and chips in the dealer's chip tray. Data relating to the tracked chips on the game table and in the chip tray can be transmitted to other software modules.

In another aspect, the invention can include a card shoe software that processes signals from the automatic card shoe system to identify the game related value, such as for example rank and suite, of at least one card immediately prior to its withdrawal from the shoe by a dealer. Data relating to the identified cards can be transmitted to other software modules.

In yet another aspect, the invention can include a game tracking software that can receive input from all other software modules and can correlate the data with known rules of the game and expected casino procedures to track gaming events in real time. The game tracking software can track all game events including wagers, game outcomes, payouts, player playing patterns and cash buyins. The module can automatically keep track of all current activity on the gaming table. At the end of each game the data relating to tracked events can be sent to a central database while alerts can be sent to a reporting station(s). In a further aspect, the invention can include an analysis and reporting software module which can determine statistics in the play of game relative to the rules of the game or relative to predetermined criteria. It can utilize reporting terminals to report game related information. The reports may be, but not limited to, fraud alerts, procedure violation alerts, player profiles, monitored events and statistics.

The system can comprise of hardware and software modules that may communicate via digital means. The software modules may reside on processor(s) and may individually or collectively interface with a database for data writing or collection. The software modules may also interface with input/output devices such as keyboards, mice, touch screen devices, monitors or LCD displays.

The system design provides a modular, scalable and open interface, and therefore can be integrated with other automated systems. For example, the entire system or specific components of the system can be integrated with a current chip tracking system such as RFID embedded chip tracking in order to improve accuracy of tracking. The system or components thereof can be integrated into table games that employ progressive winning/gaming rules. The system or components thereof can be integrated into online gaming systems to allow remote customers to play with a real live casino table and setting.

### BRIEF DESCRIPTION OF THE DRAWINGS

The following diagrams are given by way of example only, such that:

FIG. 1: Isometric view of a game table utilizing the present invention, showing system hardware

FIG. 1A: Overhead view of a gaming region showing embodiment With feedback apparatus

FIG. 1B: Overhead view of a gaming region showing embodiment with RFID chip tracking

FIG. 2: Lateral view of imaging systems of the present invention

FIG. 2A: Lateral plan view of overhead imaging system

FIG. 2B: A planar or overhead view of the gaming region imaged by an overhead imaging system

FIG. 2C: Top planar view of a dealer's chip tray

FIG. 2D: A top plan view of lateral imaging system

FIG. 2E: Top view of a number of discrete fields-of-view of respective imagers of a lateral imaging system

FIG. 2F: Lateral view of a stack of chips and color regions on chips

FIG. 2G: Illustration showing examples of gaming objects

FIG. 3: Lateral schematic of automatic card shoe system

FIG. 3A: Top plan view of automatic card shoe system

FIG. 3B: Illustration showing field of view of imager inside automatic card shoe system

FIG. 4A: Demonstration of a result of card positioning method

FIG. 4B: Demonstration of a result of card identity method

FIG. 5: Block diagram showing main modules of system

FIG. 6: Flowchart of card shoe software module

FIG. 7A: Flowchart of positioning module

FIG. 7B: Flowchart of identity module

FIG. 8: Flowchart of chip identity module

FIG. 9: Flowchart of chip tray reading software

FIG. 10: Flowchart of game tracking software module

### DETAILED DESCRIPTION OF THE PREFERRED EMBODIMENTS

The following description provides a detailed explanation of the game monitoring system and methodology. It is assumed that the person skilled in the art has some background in software development, computer networks, image processing/computer vision concepts and algorithms and systems design engineering. The headings and example scenarios provided herein are for convenience only and do not interpret the scope or meaning of the invention.

Visible symbols to which the invention is applicable is not limited to human visible symbols and can be extended to machine visible symbols. For example, infra red or ultra violet spectrum of light may be utilized by the vision processing components of the invention. In addition, in order to assist with the vision processing additional sources of light can be utilized in conjunction with the invention. Additional sources of lighting include incandescent, fluorescent, halogen, infra red and ultra violet lighting.

The term point, in this description refers to a pixel or group of closely located pixels with coordinate values defining its spatial position in a coordinate system associated with the image containing the point.

This description begins with a general overview of the gaming environment, with respect to table games. For relevance, the game blackjack has been chosen to explain the functioning of the monitoring system. It is assumed that the reader of this description knows the rules and operation of blackjack. The main functional modules of the monitoring system, including the nature of communications between the modules have been explained. Then the hardware modules of the system have been described. After the main functional modules and the hardware have been explained, the individual software modules have been described in detail. The detailed description ends with a discussion on how specific components of the design could be implemented in different ways and possible additional components for the system.

1. Game Table Environment:

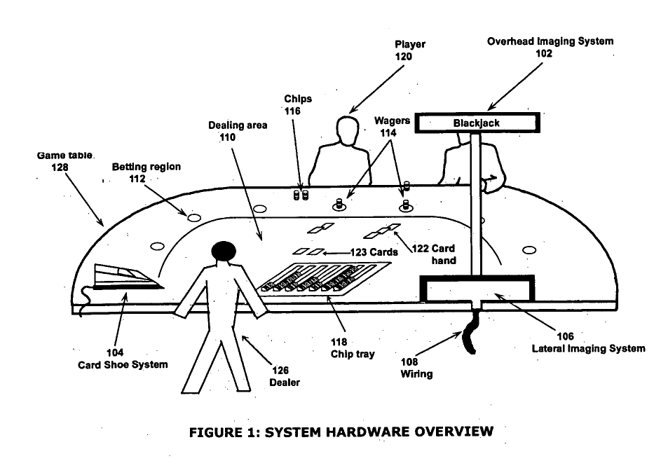

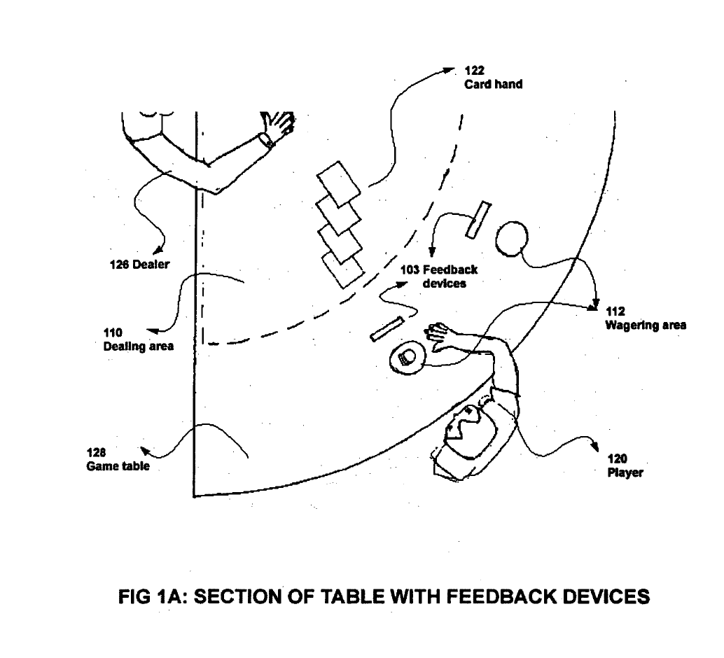

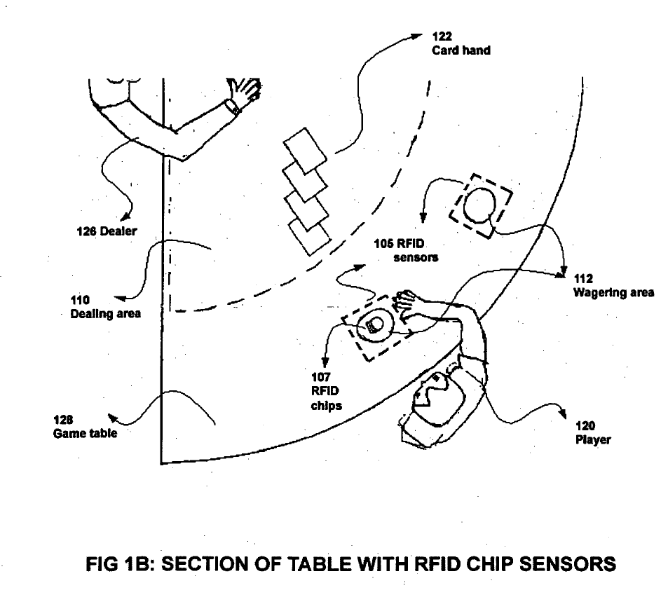

With reference to FIG. 1, an isometric view of a game table 128 for the game of blackjack is shown. The game operator is called the dealer 126. A customer also called a player 120 is shown on the curved side of the table 128.

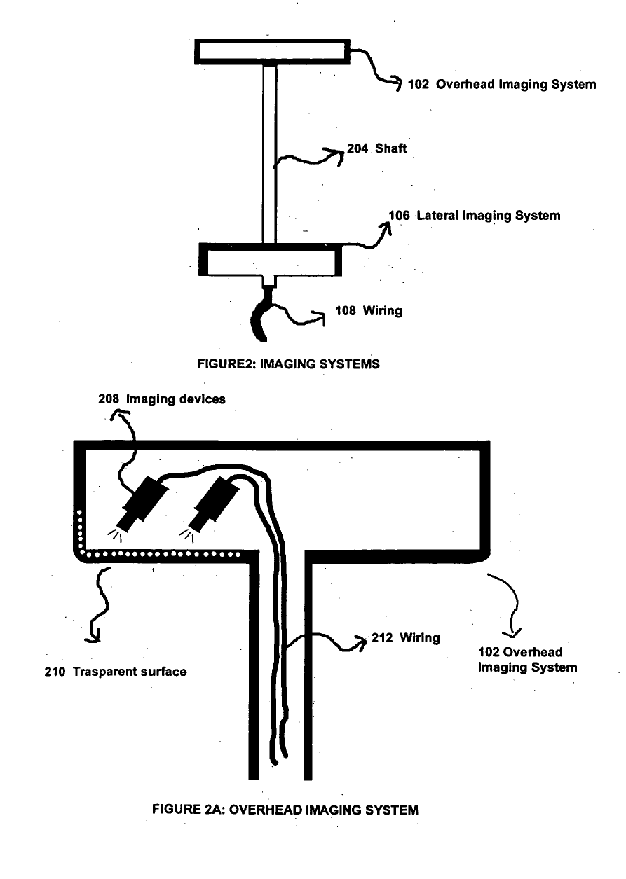

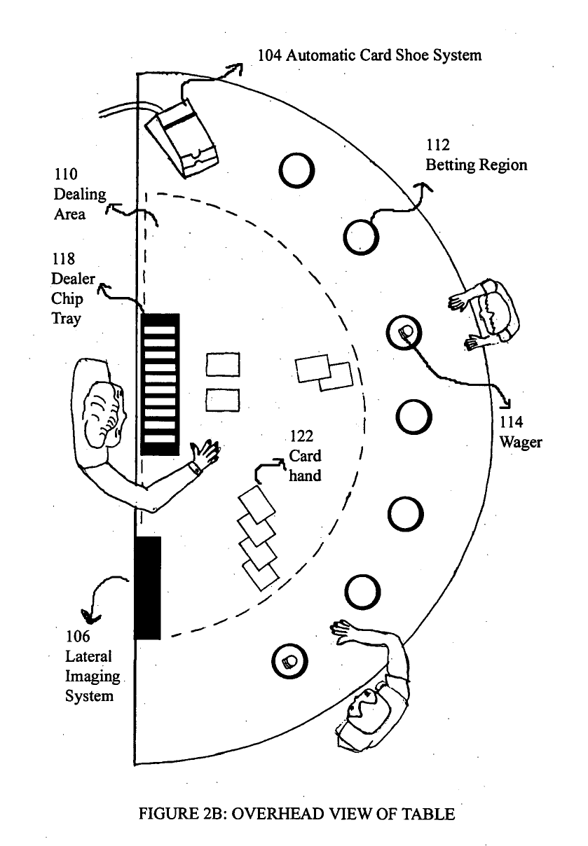

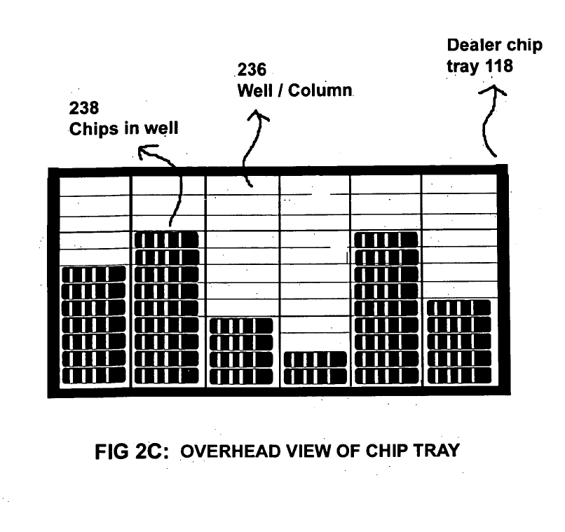

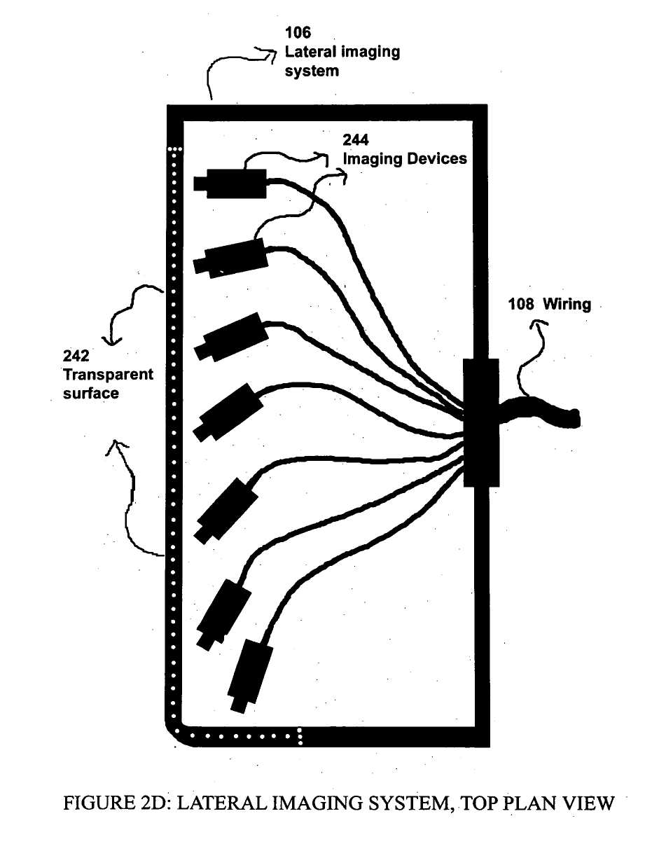

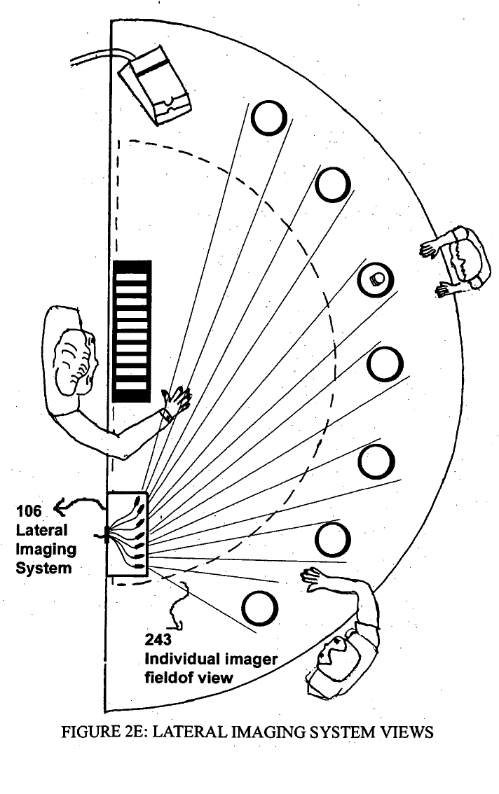

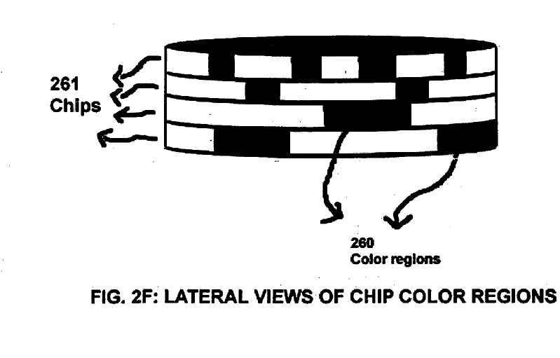

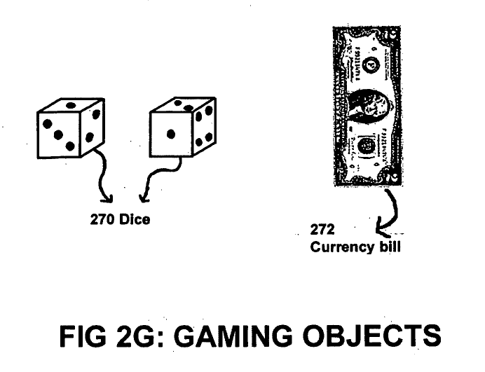

At the beginning of every game the players 120 that wish to play place their wager 114, usually in the form of gaming chips 116, in the betting region 112 (also known as betting circle or wagering area). Chips 116 can be added to wagering areas 112 during the course of the game as per the rules of the game being played. The dealer 126 then initiates the game by dealing the playing cards 123 from an automatic card shoe system 104 onto the game table 128. The dealer 126 can deal the playing cards 123 into a region called the dealing area 110. The dealing area 110, also referred to as playing area 110, may have a different shape or a different size than shown in FIG. 1. The playing area 110, under normal circumstances, is clear of foreign objects and usually only contains playing cards 123, the dealer's 126 body parts and known gaming objects 123, 122, 116, 114, 272 (in FIG. 2G), 270 (in FIG. 2G). During the progression of the game, playing cards 123 may appear, move, or be removed from the dealing area 110 by the dealer 126. The dealing area 110 may have specific regions outlined on the table 128 where the cards 123 are to be dealt in a certain physical organization otherwise known as card sets or “card hands” 122, including overlapping and non-overlapping organizations. It is noted that chips 116, cards 123, card hands 122, currency bills 272 (in FIG. 2G) and dice 270 (in FIG. 2G) can be collectively referred to as gaming objects. For the purposes of this description, the term “gaming region” can refer to a section of the game table 128 or the entire game table 128.

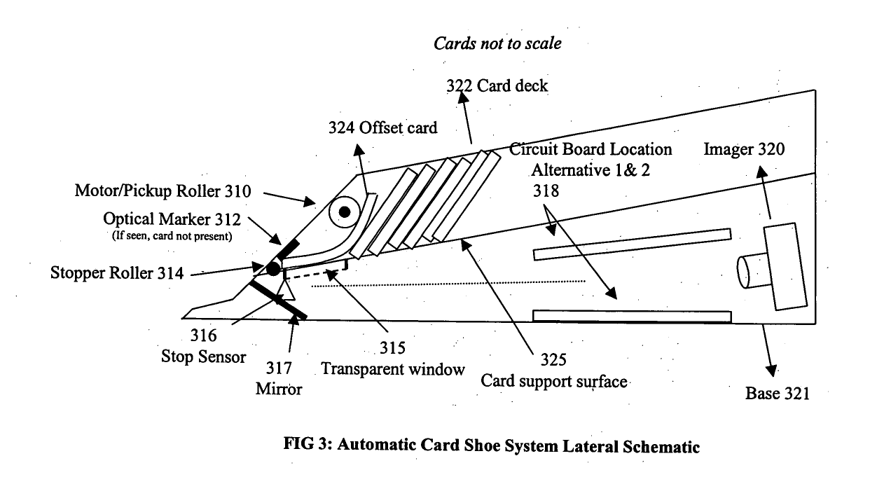

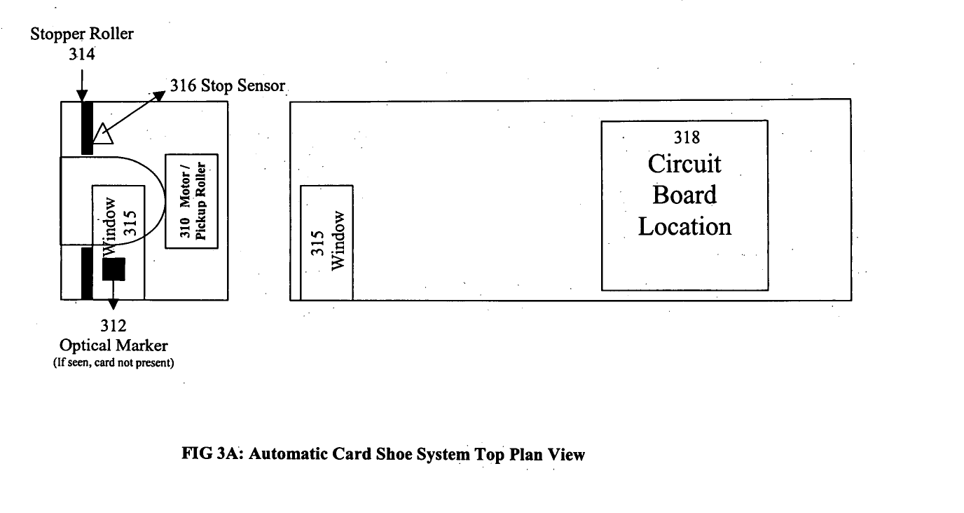

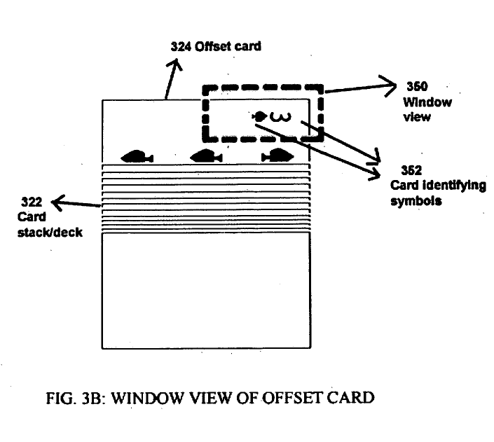

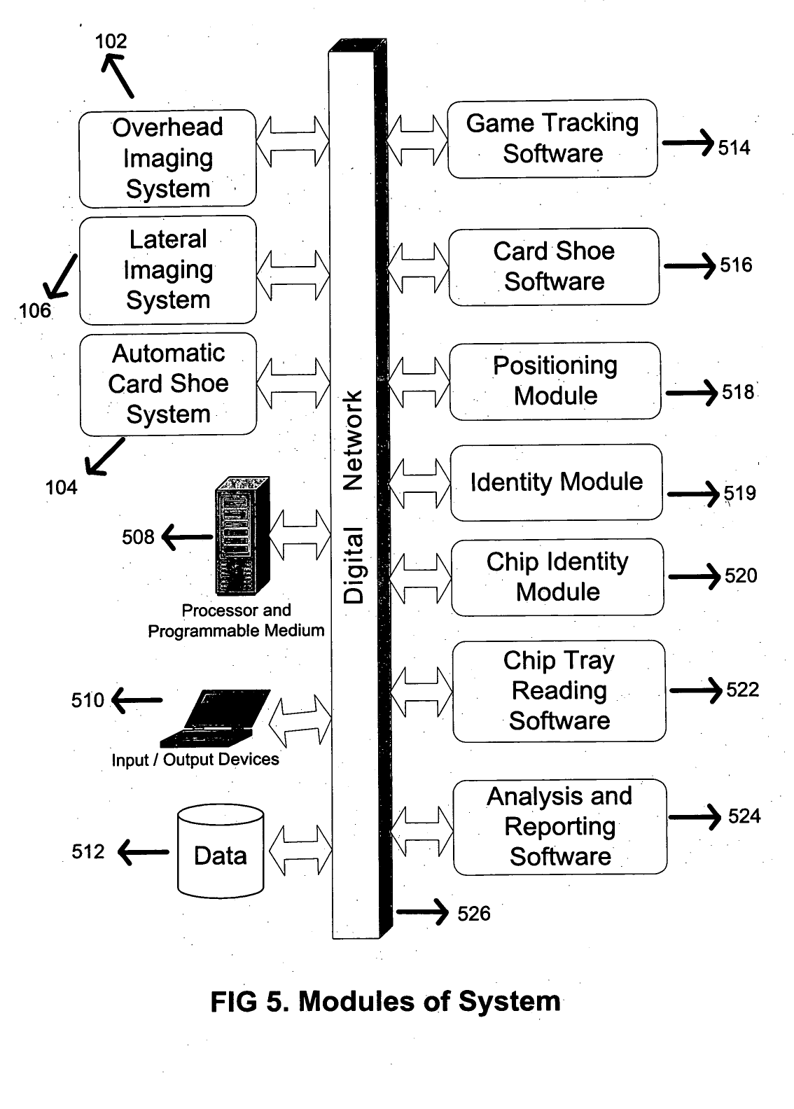

Automatic card shoe system 104 dispenses at least one card 324 (in FIG. 3) at a time for the dealer 126 to withdraw and deal onto the game table 128. The automatic card shoe system 104 also images at least one card 324 (in FIG. 3) immediately prior to its withdrawal from the card shoe 104. The automatic card shoe system 104 can image card identifying symbols 352 (see FIG. 3B) of an offset card 324 (in FIG. 3). The captured images can be processed by a card shoe software 516 (in FIG. 5) to identify a game related value, such as for example rank and suite, of a card 324 (in FIG. 3) that can be dispensed. Automatic card shoe system 104 can be connected to a power supply and a processor 508 (in FIG. 5) through appropriate power and communication means (not marked).

Imaging systems 102, 106 can be located on or beside the gaming table 128 to image the table 128 from a top view and/or from a lateral view. An overhead imaging system 102 can periodically image the table 128 from a planar overhead perspective. A lateral imaging system 106 can periodically image the table 128 from a lateral perspective. Imaging systems 102, 106 can be connected to a power supply and a processor 508 (in FIG. 5) through an appropriate power and communication means 108.

Input/output devices 510 (in FIG. 5), such as touch-pads, keyboards, magnetic swipe readers, LEDs and display screens may be present in the game environment. Input/output devices 510 (in FIG. 5) may be utilized to perform various activities related to an analysis and reporting module 524 (in FIG. 5). Output devices 510 (in FIG. 5) can be used as a feedback mechanism 103 (in FIG. 1A) to instruct the dealer 126 to perform specific actions.

The terms imaging device and imager have been used interchangeably in this document and both terms have the same meaning. The terms refer to a device(s) that can periodically produce images of a subject view. Charged Coupling Device (CCD) sensors, Complementary Metal Oxide Semiconductor (CMOS) sensors, line scan imagers, area-scan imagers and progressive scan imagers are non-exhaustive examples of imagers. Imagers may be selective to any frequency of light in the electromagnetic spectrum, including ultra violet, infra red and wavelength selective. Imagers can, without limitation, be color or monochrome. Additional sources of lighting associated with imager(s) can be utilized to improve lighting conditions for imaging. Incandescent, fluorescent, halogen, infra red and ultra violet light sources are non-exhaustive examples of lighting types.

The term ‘periodic imaging’ is such that an imager can capture a video stream at a specific number of frames over a specific period of time, such as for example, thirty frames per second. Periodic imaging can also mean that an imager can be triggered via software or hardware means to capture an image upon the occurrence of specific event(s) such as for example, if a stack of chips is placed in a wagering region and a positioning module can detect this event and can send a trigger to a lateral imaging system to capture an image of the wagering region.

For the purpose of this description, the term gaming chip or chip generally refers to wagering pieces used in a game, and can potentially include plaques, jetons, wheelchecks and RFID embedded wagering pieces.

In this description, the terms “game value of a gaming object” can refer to a value of the gaming object with respect to a game being played. For example, for a game of blackjack, a playing card having rank two (2) and suite clubs can be assigned a game value of two, or for example for the purpose of security a playing card can be assigned a game value as its rank and suite.

2. Main Modules of the System:

With reference to FIG. 5, main modules are illustrated. Hardware modules include an overhead imaging system 102, lateral imaging system 106 and automatic card shoe system 104. Software modules include game tracking software 514, card shoe software 516, positioning module 518, identity module 519, chip identity module 520, chip tray reading software 522 and analysis and reporting software 524.

Modules 102, 104, 106, 514, 516, 518, 519, 520, 522, 524 can communicate with one another through a digital network 526. A 100 Mbps Ethernet Local Area Network or Wireless Network can be used as the digital network 526. The digital network 526 is not limited to the specified implementations, and can be of any other type, including local area network (“LAN”) and/or a wide area network (“WAN”), wired and/or wireless, Internet, or World Wide Web, and can take the form of a proprietary extranet. A processor 508 or multiple processors 508 can be employed to operate software modules 514, 516, 518, 519, 520, 522, 524 and to coordinate their interaction amongst themselves, with the hardware modules 102, 104, 106 and with input/output devices 510. Further, processor(s) 508 may use stored data in database(s) 512 for providing operating parameters to any of the modules 102, 104, 106, 514, 516, 518, 519, 520, 522, 524. Software modules 514, 516, 518, 519, 520, 522, 524 may write data to database 512 or collect stored data from database 512. Further, input device(s) 510, such as a keyboard, can be used to input operational parameters and other required system data into stored data 512 or directly to a system interface (not shown). It is recognized that modules 102, 104, 106, 514, 516, 518, 519, 520, 522, 524 can comprise of software or computing hardware on any combination thereof and the system can include additional modules (not shown). Further, computer readable media (not shown) such as hard drives, floppy disks, CDs, can be used to provide the operating instructions/data to the processor(s) 508 for setting up and operating modules 102, 104, 106, 514, 516, 518, 519, 520, 522, 524.

An overhead imaging system 102 periodically images the gaming table 128 (in FIG. 1) and dealer's chip tray 118 (in FIG. 1) from an overhead perspective. A lateral imaging system 106 periodically images the gaming table 128 (in FIG. 1) from a lateral perspective so as to provide a side view of chips and stacks of chips (see FIG. 2F) on the gaming table 128 (in FIG. 1), specifically the wagering regions 112 (in FIG. 1) and wagers 114 (in FIG. 1).

An automatic card shoe system 104 can offset a foremost card 324 (see FIG. 3) of a card deck 322 (see FIG. 3) and can image or scan machine readable symbol(s) 352 (see FIG. 3B) on the offset card 324 (see FIG. 3B) prior to the offset card's 324 (in FIG. 3) withdrawal from the card shoe system 104. The automatic card shoe system 104 can send captured symbol 352 (see FIG. 3B) data associated with an offset card 324 (see FIG. 3B) to a card shoe software module 516.

A card shoe software module 516 can receive input from automatic card shoe system 104 and can process input to determine a game related identity of at least one offset card 324 (see FIG. 3).

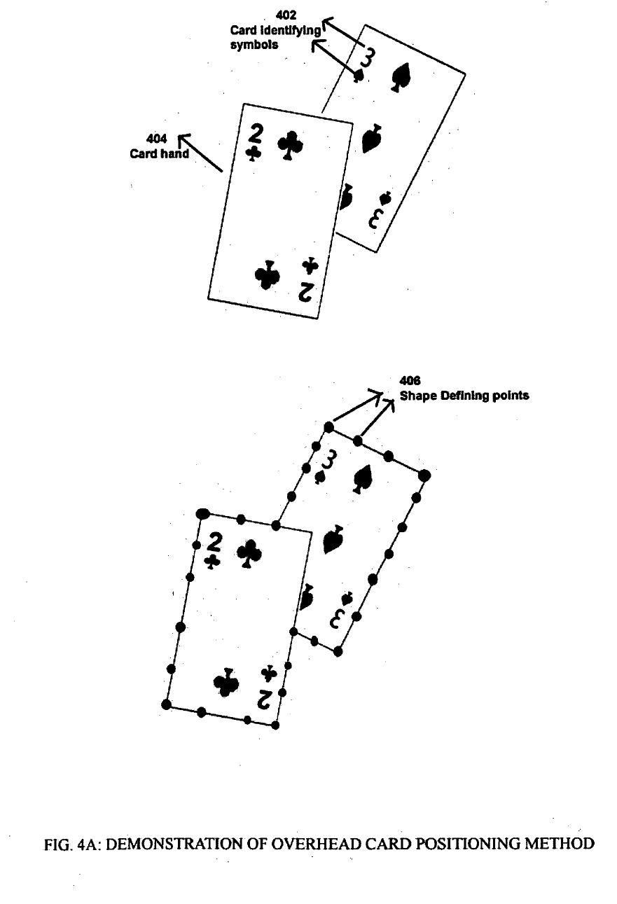

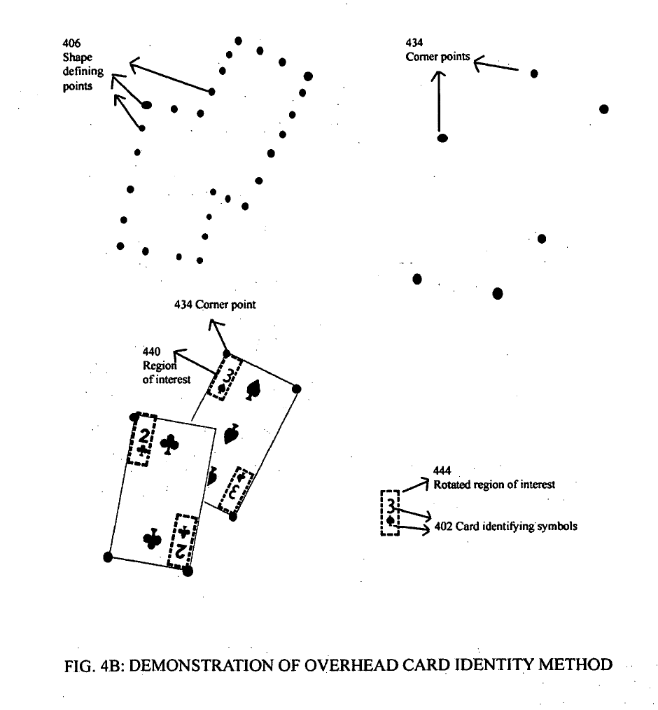

A positioning module 518 can receive input from overhead imaging system 102. The positioning module 518 can process images to recognize gaming objects and to determine and assign a position indicator including at least one characteristic point, such as for example a sequence of boundary points 406 (in FIG. 4A), for each gaming object, such as for example a card hand 404 (in FIG. 4A).

An identity module 519 can determine a game related identity, such as for example card rank or currency bill value, of each gaming object detected by the positioning module 518.

A chip identity module 520 can receive images from the lateral imaging system 106 and/or overhead imaging system 102. The chip identity module 520 can process images to determine position and identity of wagering pieces, such as for example casino chips, in the images of the gaming table 128 (in FIG. 1) and/or dealer's chip tray 118 (in FIG. 1).

A chip tray reading software module 522 can receive input from the overhead imaging system 102. The chip tray reading software 522 can apply chip identity module 519 to images of the dealer's chip tray (as shown in FIG. 2C) from the overhead imaging system 102 to automatically identify chips 238 (in FIG. 2C) in the chip tray 118 (in FIG. 1).

A game tracking software module 514 can receive input from other software modules 514, 516, 518, 519, 520, 522, 524. The game tracking software 514 can interpret input to determine a game related events happening at the game table 128 (in FIG. 1). The software 514 can determine the current status of the game, at any point in the game. Based on events detected on the game table 128 (in FIG. 1), the software 514 can determine if any specific actions need to be taken. For example, the software 514 may detect a dealer 126 (in FIG. 1) procedure violation and send an alert to an output device 510 such as a computer monitor. The game tracking software 514 can determine and compile a history of game events for each game played at the gaming table 128 (in FIG. 1). Data representing history and results of each game can be sent to an analysis and reporting module 524.

An analysis and reporting software module 524 (not shown) can receive input from all other software modules 514, 516, 518, 519, 520, 522, 524. It 524 can perform player profiling, player compensation calculation, fraud detection, game statistical calculations and efficiency measurements and can report them through a user interface to casino personnel on output device(s) 510 such as printed reports and/or a computer screen. The analysis and reporting software module 524 is not limited to the functions described above; it may perform other analysis of recorded game data that casino personnel may require. The software 524 may interface with a database 512 to store detected data or for data collection, analysis and reporting purposes.

Modules 102, 104, 106, 514, 516, 518, 519, 520, 522, 524 in combination or in subsets of combinations can monitor and gather data on game related events happening at a casino game table 128 (in FIG. 1). Detected events can be analyzed and appropriate actions can be taken such as player profiling, procedure violation alerts, fraud alerts. In addition, reports can be generated to indicate statistics on game related activities, such as for example, profitability, employee efficiency and player playing patterns.

3. Imaging Systems:

With reference to FIG. 2, a general physical layout of an overhead imaging system 102 and lateral imaging system 106 are shown. In this embodiment, the systems 102, 106 are set up in the form of a signpost with a base. This form can be chosen so that it looks camouflaged in the form of signage and can be unobtrusively placed beside or on the surface of the gaming table 128 (in FIG. 1). A shaft 204 can be designed to be hollow so that wiring 212 (in FIG. 2A) from the overhead imaging system 102 may be lead through the shaft 204 and out through the base wiring 108. Imagers 208 (see FIG. 2A) and 244 (see FIG. 2D) can be located in housing stations that has viewing walls 210 (see FIG. 2A), 242 (see FIG. 2D) made of a material that is transparent from the perspective of the imagers 208 (in FIG. 2A) and 244 (in FIG. 2D). The material for the viewing walls 210 (in FIG. 2A), 242 (in FIG. 2D) can be transparent or one-way transparent or tinted, as used in housing systems for CCTV and surveillance applications. In another embodiment, the housing for imaging systems 102, 106 can include an opaque material with holes sized to hold the head or lens of the imagers 208 (in FIG. 2A) and 244 (in FIG. 2D).

The shape and organization of the housing(s) for the imaging systems 102, 106 may take different forms without compromising their function. The lateral imaging system 106 can be physically separate from the sign post (FIG. 2). The lateral imaging system 106 could be portable in nature. Optionally the imaging systems' 102, 106 housing can include an electronic display. The electronic display can optionally display game results or game related statistics as they are tracked in real time.

The housing for imaging systems 102, 106 can optionally be implemented in the form of the table's 128 (in FIG. 1) betting limit sign (not shown) in order to camouflage the imaging systems 102, 106 and allow for an angular imaging view of the table 128 (in FIG. 1).

4. Overhead Imaging System:

With reference to FIG. 2A, an overhead imaging system 102 (in FIG. 2) consists of individual imaging device(s) 208 that can optically record game events on'the game table 128 (in FIG. 1) from a top view. The interpretation of the term top view or overhead view for an overhead imager 208 can be that the top surface of a gaming object such as a playing card 123 (in FIG. 1) is visible from the perspective of the overhead imager 208 for image processing purposes, such as for example optical character recognition. For instance, an imager positioned at an angle of view that is generally between +70 degrees to −70 degrees off the line-perpendicular- to the center of the surface visible in the imager's field of view (FOV) could provide such an overhead view. This perspective, as shown by example in FIG. 2B can be generally termed as the overhead view, birds-eye-view or top-view for the purpose of this description. Planar co-ordinates can optionally be utilized to mark the position of objects on the planar game table 128 (in FIG. 1). A preferred embodiment includes the use of CMOS imagers. The number of imaging devices 208 (in FIG. 2A) may not be representative of the actual number of imaging devices 208 used in the overhead imaging system 102 (in FIG. 2). The actual number of imaging devices 208 used may be one or many, and may vary depending on the type of imaging device 208 used in the implementation. The individual imaging devices 208 may image specific regions of the game table 128 (in FIG. 1) or the entire game table 128 (in FIG. 1). A combined fields of view of imaging devices 208 in the overhead imaging system 102 (in FIG. 2) may provide an overhead view of the game table 128 (in FIG. 1) as shown by example in FIG. 2B. An advantage of using an overhead imaging system 102 (in FIG. 2) could be that it could allow tracking of gaming objects on the gaming table 128 (in FIG. 1) with relatively few imaging devices 208, as compared to a fully lateral view (not shown). Further, an overhead view (as shown in FIG. 2B) could allow the use of Cartesian co-ordinates to track the position of objects on the planar gaming table 128 (in FIG. 1).

The overhead imaging system of FIG. 2A can periodically image a dealer's chip tray 118 (in FIG. 1) from an overhead perspective, as shown in FIG. 2C.

Overhead images of a game table 128 (in FIG. 1) can be transmitted to the positioning module 518 (in FIG. 5). Overhead images of a dealer's chip tray 118 (in FIG. 1) can be transmitted to the chip tray reading software 522 (in FIG. 5).

1. Lateral Imaging System:

A lateral imaging system 106 (in FIG. 1) can be located on the game table 128 (in FIG. 1) surface and at the base of the sign post shown in FIG. 2. With reference to FIG. 2D, a potential housing for the lateral imaging system has front and sidewalls 242 made of a material that is transparent from the perspective of the imagers 244. The material may be fully transparent, one-way transparent or tinted, as used in housing systems for CCTV and surveillance applications. Alternatively the front and/or sidewalls 242 can have windows or cutouts to accommodate the imager head or lens or lighting sources. The lateral imaging system 106 (in FIG. 1) includes individual imaging device(s) 244 that can optically record game events on the table 128 (in FIG. 1) from a lateral view. The lateral view allows for viewing chips 116 (in FIG. 1) and/or wagers 114 (in FIG. 1) on the game table 128 (in FIG. 1) from a side or lateral perspective (see FIG. 2F). In addition to laterally imaging wagers 114 (in FIG. 1) and/or other gaming objects on the table, the lateral imaging system 106 (in FIG. 1) can optionally be set up to image the faces of players 120 (in FIG. 1) at the gaming table 128 (in FIG. 1). The number of imaging devices 244 may not be representative of the actual number of imaging devices 244 used in the lateral imaging system 106 (in FIG. 1). Actual number of imaging devices 244 used may vary depending on the type and field of view of imaging device(s) 244 used in the implementation. Individual imaging devices 244 may image specific regions of the game table 128 (in FIG. 1). A combined fields of view of imaging devices 244 in the lateral imaging system 106 (in FIG. 1) can provide a complete view of at least one betting region 112 (in FIG. 1). A composite field of view formed by individual fields of view 243 (in FIG. 2E) of each imaging device 244, is shown by example in FIG. 2E.

Image capture for lateral imagers 244 can be externally triggered by software or hardware means, including other software modules 514, 516, 518, 519, 520, 522, 524. Captured images can be sent to a chip identity module 520 (in FIG. 5) for processing.

2. Automatic Card Shoe System:

With reference to FIG. 3, a lateral schematic of an automatic card shoe system 104 (in FIG. 1) capable of automatically offsetting a foremost card(s) 324 from a deck of cards 322 and generating a signal indicative of the offset card's 324 identity, is shown. The shoe system 104 (in FIG. 1) consists of a base 321, a card compartment 325 also called a card support surface 325 and an actuation mechanism 310 to offset at least one front most card 324 from the rest of the deck 322 and positioned so that a dealer 126 (in FIG. 1) can withdraw a front most card 324 from the shoe 104 (in FIG. 1). The actuation mechanism 310 can be implemented as a motor/pickup roller unit and can be directed by an associated control circuit 318 and a stop sensor 316. The stop sensor 316 senses when a card 324 is located on top of it. The stop sensor 316 can consist of an IR emitter and light sensor pair. The motorized roller unit 310 turns on when a card has been withdrawn and no card is triggering the stop sensor 316. As a next front card 324 is offset by the motorized roller unit 310 the card 324 can slide over the card support surface 325, onto a transparent window 315 and over the stop sensor 316. When the card 324 triggers the stop sensor 316 the control circuit 318 stops the motorized roller unit 310 and the offset card 324 is positioned stationary over the transparent window 315 and is ready to be withdrawn. This process can be repeated for every foremost card or card set. In order to ensure consistent positioning of the offset card 324 a stopper roller 314 or flap can be placed near the lip (not shown) of the shoe 104 (in FIG. 1) where the card is to be Withdrawn.

A mirror 317, reflective surface or prism can be placed under the card support surface 325 and directly under the transparent window 315, can deflect or reflect light from the offset card 324 to an imager 320, which can be located at the back of the card shoe 104 (in FIG. 1), under the card support surface 325. The mirror 317 can be positioned at an angle so as to allow a clear image of the offset card 324 from the perspective of the imager 320. In order to obtain a clear image of the offset card 324, lighting sources (not shown) such as LEDS can be placed under the card support surface 325. These LEDs can emit light in any spectrum including infra red, ultraviolet and visible light. Control circuit 318 can be placed flat on the base 321, under the card support surface 325. The imager 320 can periodically image offset cards 324 and can transmit these images to a card shoe software 516 (in FIG. 5). The imager 320 can be triggered to capture an image(s) by sensors or hardware or software based triggering means (not shown). An optical marker 312 can be placed to assist with detection of an offset card. If the optical marker 312 is not visible from the perspective of the imager 320, it can be inferred that a card 324 is probably positioned over the transparent window 315.

With reference to FIG. 3B, a view 350 of an offset card 324 from the perspective of an imager 320 (see FIG. 3) is shown. Identifying symbols 352 on the exposed card surface can be visible from the perspective of the imager 320 (see FIG. 3) through a transparent window 315 (see FIG. 3A) on the card support surface 325 (see FIG. 3).

The automatic card shoe system of FIG. 3 can additionally have a mechanism to turn the device on or off by means of a button on the backside of the shoe system of FIG. 3 or by means of additional sensors that can detect when a card deck is removed from the shoe system of FIG. 3.

With reference to FIG. 3A, a top plan view of the automatic card shoe system 104 (in FIG. 1) is shown, illustrating a location for the control circuit 318, a transparent window 315, motorized roller unit 310, stopper roller 314, an optical marker 312, and stop sensor 316.

The automatic card shoe system 104 (in FIG. 1) can include a digital and/or power connection (not marked) leading out from the backside of the shoe to a processor. Alternatively the shoe 104 (in FIG. 1) can have an embedded processor contained inside. The automatic card shoe system 104. (in FIG. 1) can be powered by an external or internal power source.

An advantage of imaging an offset card 324 (in FIG. 3) before it is dealt is that the image could be that of a stationary object. Since a stationary object is being imaged, blur on the image will likely be less compared to a system (not shown) where imaging is performed on moving cards while they are being dealt from a shoe. A blurred image can impede Optical Character Recognition (OCR) accuracy. A non-blurred image of a stationary card can enable superior OCR accuracy. Imaging a stationary card can also allow the use of imagers that have lower frame rates, than that possibly required to image a card in motion.

In another embodiment of the automatic card shoe system 104 (in FIG. 1), instead of using an imager 320 (in FIG. 3) a scanner (not shown) can be utilized. A scanner can be placed directly under the transparent window 315 (in FIG. 3). Instead of existing card graphics, other machine readable indicia such as for example barcodes can potentially be utilized to scanned cards.

For the purpose of this description, a card dispensing system capable of generating signals indicative of the cards being dispensed can be termed as a card reader or card reading system. The automatic card shoe system 104 (in FIG. 1) can be generally called a card reader or card reading system. Other non-exhaustive examples of card readers include card shoe systems that scan or image cards while being dispensed (in motion) or prior to being dispensed and automatic shufflers with a capability to scan or image cards.

3. Positioning Module:

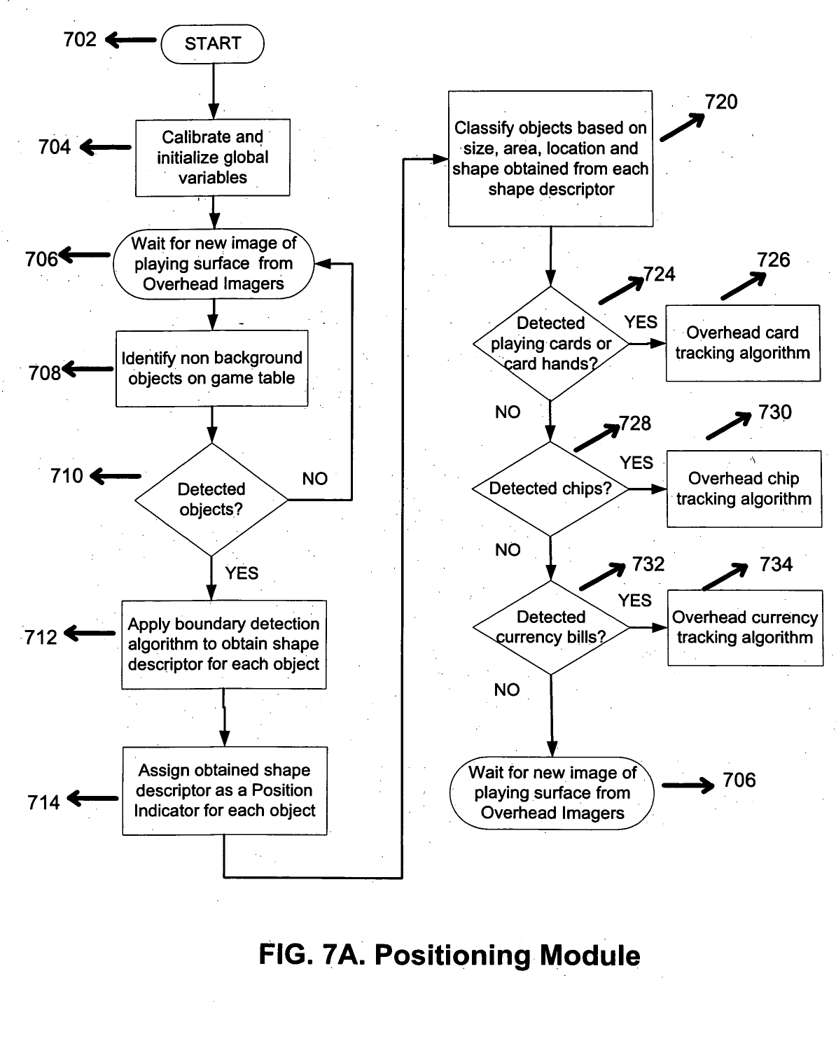

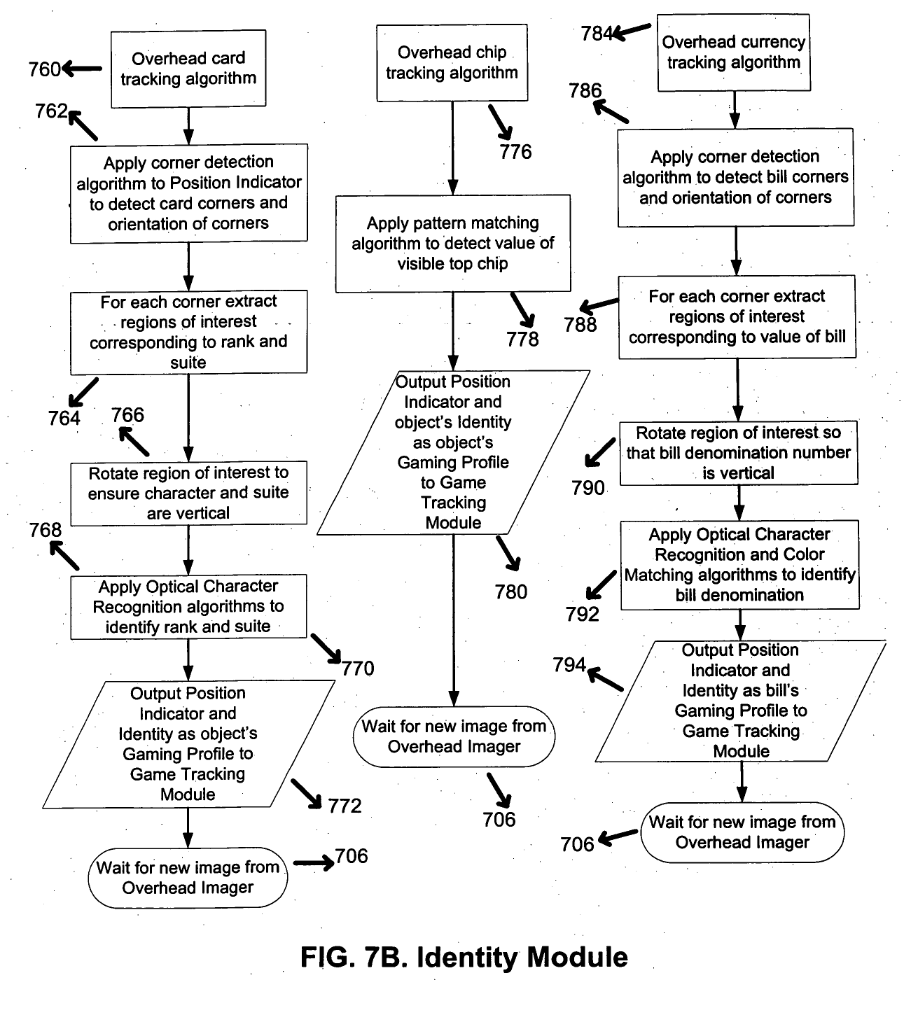

With reference to FIG. 7A, a positioning module 518 (in FIG. 5) can process images from the overhead imaging system to recognize gaming objects on the game table 128 (in FIG. 1) and can determine and assign a position indicator for each detected gaming object. Images can periodically received from the overhead imaging system 102 (in FIG. 1), and these images can provide a planar view of a gaming area 128 (in FIG. 1) including dealing area 110 (in FIG. 1) and betting regions 112 (in FIG. 1). Location of cards 123 (in FIG. 1) and other gaming objects can be represented using planar co-ordinates, such as but not limited to Cartesian 2-D coordinates. For the purpose of using planar co-ordinates, any point in an overhead image can be chosen as the origin.

The positioning module 518 (in FIG. 5) can employ image processing and/or computer vision algorithms.

With reference to FIG. 7A, the software starts at step 702 and in step 704 it can load operating parameters such as for example table layout characteristics and location of betting circles, into memory. The software can wait for a new image from the overhead imaging system 102 (in FIG. 1) in step 706. When a new image is received, in step 708 objects on the gaming table can be recognized. The appearance characteristics of the table 128 (in FIG. 1) such as layout color and layout design are pre-known parameters. An image of the table surface 128 (in FIG. 1), when it is clear of objects, can be utilized as a background template. This background template can be stored in memory. For each image received from the overhead imaging system 102 (in FIG. 1), the new image can be compared to the stored background template in order to identify foreign objects and eliminate the background or layout from the image. In this manner objects can be recognized in step 708.

Following step 708, if any objects are detected in the new image in step 710, software proceeds to step 712. In step 712, each object's shape can be determined by applying a boundary detection or shape detection algorithm. For example, an algorithm that traverses edges in an edge detected image can assist in identifying an object's boundary. FIG. 4A shows the results of a shape detection algorithm on an image containing an object which is a card hand 404. With reference to FIG. 4A, card identifying symbols are the card indicia 402. A shape detection algorithm used in step 712 can produce characteristic points 406 on the boundary of the card hand. These boundary points 406 or characteristic points 406 define the shape of the object and therefore the sequence of points for this object can form a shape descriptor 406 (see FIG. 4B) that can be assigned as a position profile in step 714 for the gaming object 404.

In this description, the terms shape descriptor and boundary descriptor are used interchangeably and they both have the same meaning. A shape descriptor 406, can also be termed as a position profile. A position profile of an object can include at least one characteristic point indicative of the shape and/or location of an object, such as for example a corner point, sequence of corner points, boundary points, a sequence of boundary points, boundary lines, boundary curves, object edges, bounding boxes or subsets of the foregoing in a coordinate system with respect to the image of the game table 128 (in FIG. 1). FIG. 4A shows by example, a series of boundary points 406, as a card hand's 404 position profile. A sequence of corner points of the card hand 404 can also be utilized as the card hand's 404 position profile.

With reference to FIG. 7A, in steps 720, the object's position profile can be analyzed based on its characteristics such as for example, size, area, dimensions and shape to recognize and classify gaming object as cards, card hands, chips, currency bills or other relevant gaming object.

In step 726, if an object can be classified as a card or card hand, the Identity Module 519 (in FIG. 5) can be started at step 760. In step 728, if an object can be classified as a chip or chip stack the Identity Module 519 (in FIG. 5) can be started at step 776. In step 732, if an object can be classified as a currency bill, the Identity Module 519 (in FIG. 5) can be started at step 784.

4. Identity Module:

An identity module 519 (in FIG. 5) receives position indicators for each recognized gaming object and identifies the game related value of each gaming object.

With reference to FIG. 7B, in step 762, if a gaming objects can be recognized as a card or card hand 404 (in FIG. 4A) a corner detection algorithm can be applied to the gaming object's shape descriptor 406 (in FIG. 4B) to detect the corner points 434 (in FIG. 4B) of the playing cards in the card hand 404 (in FIG. 4A). In step 764, for each corner point 434 (in FIG. 4B), the corner's orientation angle can be determined based on its relative location with respect to the other corner points 434 (in FIG. 4B) of the card. The location of the card identifying symbols 402 (in FIG. 4B) on playing cards are a pre-known operating parameter. Utilizing the location of a corner point 434 (in FIG. 4B) as a seed point and based on its orientation, a region of interest 440 (in FIG. 4B) containing card identifying symbols 402 (in FIG. 4B) can be extracted. In step 766, the extracted region of interest 440 (in FIG. 4B) can be rotated by the corner orientation angle (not shown) in order to obtain an upright image 444 (in FIG. 4B) of the card identifying symbols 402 (in FIG. 4B) of each card.

In step 768, optical character recognition (OCR) algorithms can be applied to the rotated region of interest 444 (in FIG. 4B) to identify the game related value the card, such for example the rank and suite. In step 772, the identified cards and their position indicators can be sent to the game tracking software module 514 (in FIG. 5).

For chip stacks 114 (in FIG. 2B) a bounding box or bounding circle (not shown) can be utilized as a position indicator. With reference to FIG. 7B, in step 778 the top chip of the stack 114 (in FIG. 2B) can be examined based on its colors and patterns to match it to pre-known colors and patterns of chips stored in memory in order to identify value of top chip in the chip stack 114 (in FIG. 2B). Once identified, in step 780 the position indicator of the chip stack and/or the value of the top chip in the stack can be transmitted to the game tracking software module 514 (in FIG. 5).

With reference to FIG. 7B, in step 786 a corner detection algorithm can be utilized to identify the corners of currency bills 272 (in FIG. 2G), or the corners can be obtained directly from the shape descriptor or position indicator for the currency bill 272 (in FIG. 2G). In step 788, utilizing a corner as a seed point, a region of interest can be extracted potentially containing bill identifying data such as color, denominational marks or patterns. In step 790 the region of interest can be rotated to an upright position utilizing the orientation information about its corresponding corner point. In step 792 pattern matching algorithms or OCR algorithms can be applied to potentially detect the value of the bills. In step 794, the detected values of bills can be transmitted to the game tracking module 514 (in FIG. 5).

In an alternate embodiment, in order to assist with the positioning module 518 (in FIG. 5) and/or identity module 519 (in FIG. 5), characteristic marks can be printed on cards using a special kind of ink that can be distinctly imaged and recognized using an appropriate type of imaging device. Special types of machine readable symbols can include symbols visible in specific spectrum of light such as infra red or ultra violet. Accordingly, a machine readable shape descriptor can be printed on the cards.

The positioning module 518 (in FIG. 5) can also identify motion on the gaming table by examining differences position indicators of gaming objects between subsequent image frames. Motion detection from overhead view can assist the chip identity module 520 (in FIG. 5). For example, the positioning module 520 (in FIG. 5) can detect when chips 114 (in FIG. 2B) have been wagered and are stationary and can send an indicator to the chip identity module 520 (in FIG. 5) to trigger the software method for identification of chips/wagers 114. (in FIG. 1). Such a trigger can also be sent to the lateral imaging system 106 (in FIG. 5) to capture an image(s) of the relevant betting regions 112 (in FIG. 1). Consequently, the chip identity module 520 (see FIG. 5) can be triggered to processes images when wagers 114 (in FIG. 1) appear stationary between subsequent image frames, which can potentially save processing power and can potentially improve tracking accuracy.

In an alternate embodiment, the identity module 520 (in FIG. 5) can potentially forego the identification of cards/card hands 122 (in FIG. 2B) by processing overhead images. The identity of cards 123 (in FIG. 1) entering the game area 110 (in FIG. 1) or game table 128 (in FIG. 1) can be determined through a card reader, such as for example the automatic card shoe system 104 (in FIG. 1) and its associated card shoe software 516 (in FIG. 5).

5. Card Shoe Software Module:

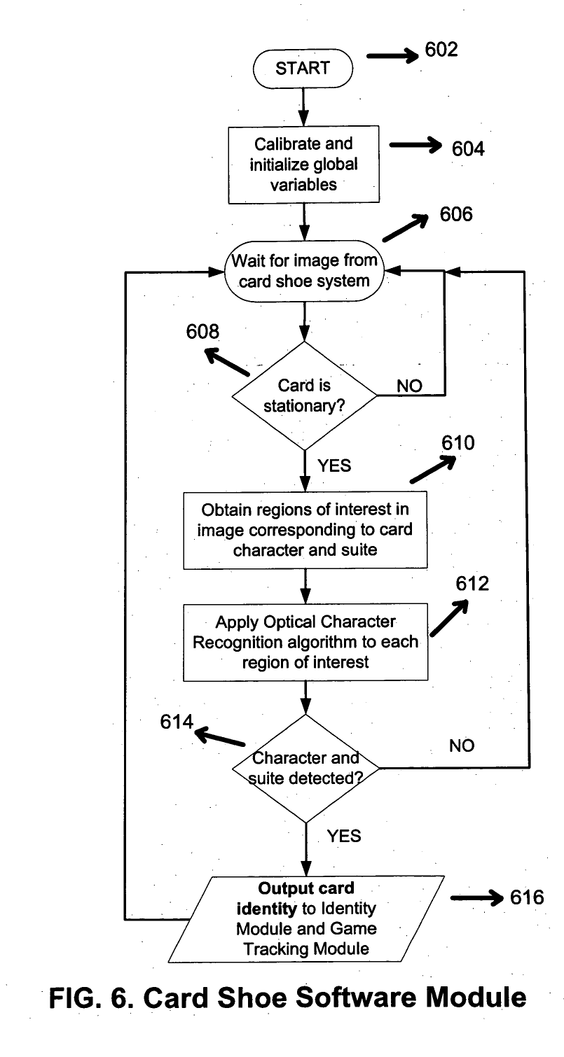

With reference to FIG. 6, a card shoe software module 516 (in FIG. 5) can receive input from an automatic card shoe system 104 (in FIG. 1) and can process the input in to determine the game related value, such as for example rank and suite, of cards dealt from the card shoe system 104 (in FIG. 1). In step 604, the software loads operational parameters, such as for example card templates, into memory. In step 606, the software waits for a new image from the automatic card shoe system 104 (in FIG. 5). Once a new image is received, in step 608 the software can scan the image for an optical marker 312 (in FIG. 3) indicative of the absence of a card. If a marker 312 (in FIG. 3) is not found, a card is assumed to be present and stationary in the image. In step 610, regions of interest corresponding to the expected location of card identifying symbols 352 (in FIG. 3B) can be established using segmentation algorithms. In step 612, OCR algorithms can be applied to each detected region of interest (not shown) in order to identify a game related value for the card. If a game related value is identified in the image then, in step 616 the card identity can be sent to the game tracking software 514 (see FIG. 5).

In an alternate embodiment, signals that can be received from the automatic card shoe system 104 (in FIG. 5) can be any type of machine readable signal indicative of the game related value of the offset card (324 in FIG. 3). The software can be designed to appropriately process the machine readable symbols to identify the rank and suite of the offset card 324 (in FIG. 3). Machine readable indicia can also include barcodes and unique identifiers for each playing card.

6. Chip Identity Module:

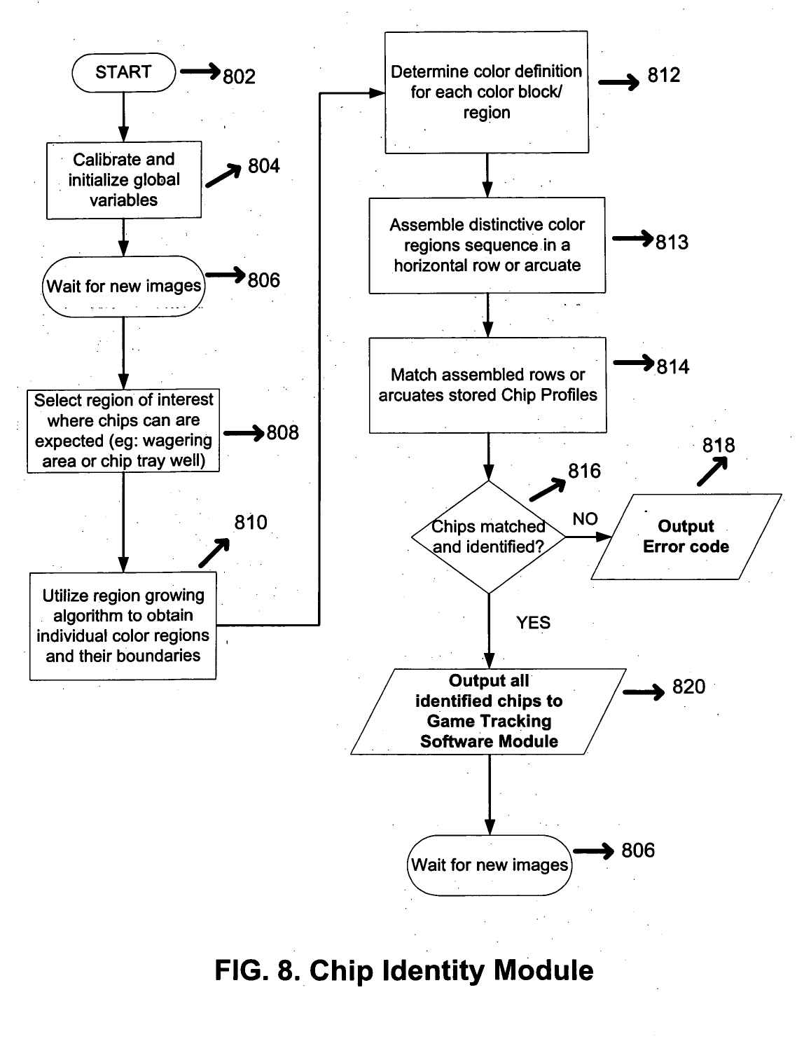

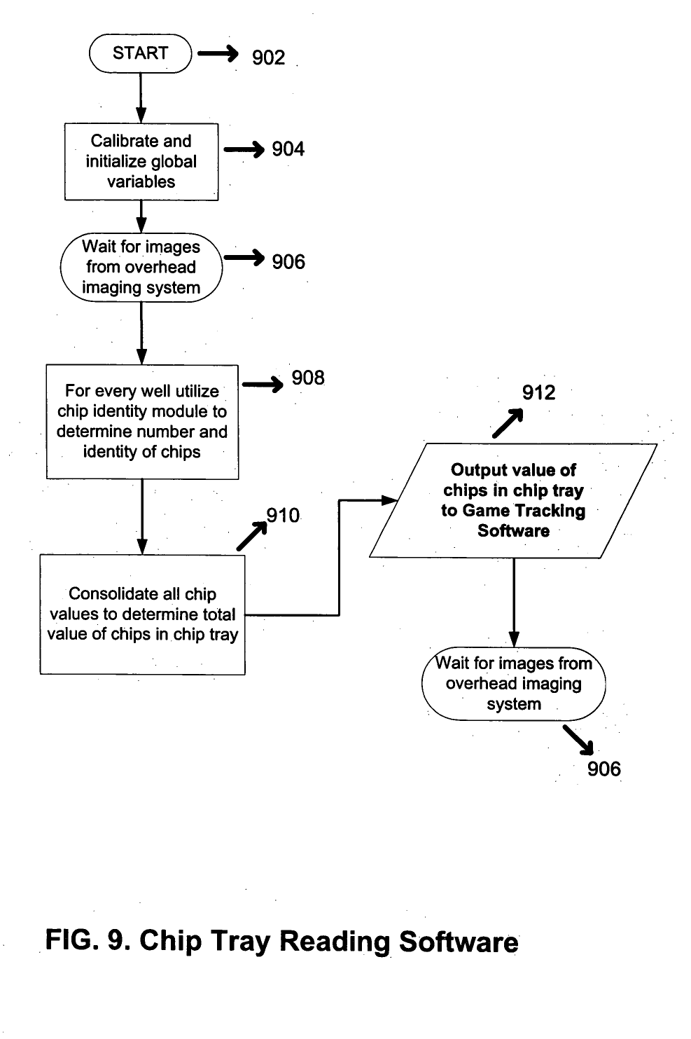

With reference to FIG. 8, a chip tracking identity module 520 (in FIG. 5) can periodically receive images as input and can determine the number and denomination of chips in each image.

Images received from a lateral imaging system 106 (in FIG. 5) can include a side view of all at least one betting region 112 (in FIG. 1) and chips 116 (in FIG. 1) and wagers 114 (in FIG. 1) with respect to at least one betting region in the play of the game, including payouts made by the dealer 126 (in FIG. 1) to players 120 (in FIG. 1).

The method begins at step 802 and in step 804 the software is trained and calibrated once initially with casino chips used in game play. During calibration and training in step 804, the software can create a profile of each type of chip based on geometrical and optical characteristics including, width to height ratio, absolute height, absolute width, the geometrical dimensions and arrangements of the distinct color regions 260 (in FIG. 2F) on chips 261 (in FIG. 2F) along the top and side surfaces. A profile of chips of every value or type can be stored in memory or in a database.

In step 806, software waits for a new image. In step 808 for each new image received the chip identity software can identify pre-defined regions of interest. For example, for images from the lateral imaging system 106 (in FIG. 1), the region representing the wagering area 112 (in FIG. 1) could be a region of interest. For images from the overhead imaging system 102 (in FIG. 1), the region representing each well or column 236 (in FIG. 2C) of the chip tray 118 (in FIG. 1) could be a region of interest.

In step 810, within each region of interest in the image, a color region growing algorithm can be utilized to potentially identify distinct color blocks 260 (see FIG. 2F). A region growing algorithm is a common concept in computer vision wherein a pixel is chosen as a seed point and the algorithm expands outwards in at least one dimension from the seed pixel(s) until there is a significant change in color or pixel value. In this manner a region can be obtained with relatively uniform color composition. These regions can correspond to two dimensional (2-D) color regions 260 (see FIG. 2F) on the side faces of chips 261 (in FIG. 2F)s. Each detected color region 260 (in FIG. 2F) can be represented by a polygon, such as for example a rectangle or a pentagon, depending on the characteristics of the color region 260 (in FIG. 2F). For each color region obtained after step 810, in step 812 the color characteristic of each region can be calculated. For example a median color or Gaussian mean color of the region can be utilized as its color definition. In step 813, sequences of distinctive color regions can be assembled into a rows or arcuates, depending on the angle of view of the lateral image. In step 814, the assembled rows or arcuates can be matched to stored chip profiles to determine a potential match for each sequence. When a match is found in step 816 a chip denomination can be identified for that specific sequence and the matched chips 261 (in FIG. 2F) can be output in step 820.

An advantage of using polygonal representations of color blocks is that it may not assume that a view of the chips is a perfectly lateral view. The view can potentially be angled. For instance the images can provide a 15 degrees view of the chips. In a situation where the view is angled at 15 degrees, the individual color regions can be matched to an appropriate arcuate to account for the 15 degree angle of view. Another advantage of using a polygonal representation is that it may not assume that the chip color regions on the lateral side of the chip are rectangular or that they have straight edges. The presented chip identity module 520 (in FIG. 5) can potentially work on chips with color segments of non-straight edges.

The presented method in the chip identity module 520 (in FIG. 5) can utilize visible light to image chips. However, light from non-visible spectrum including infra red and ultra violet can be utilized in conjunction with corresponding spectrum selective imagers. Chips can optionally contain pigments that selectively absorb or reflect specific wavelengths of light. For example, Chips can contain pigments that absorb or reflect infra red light. These pigments can be incorporated in the chip so as to produce a specific machine readable code. Alternatively, pigments can be incorporated into the regular chip color regions. Infra red light emitting diodes can be used to light the gaming area 110, 128 (in FIG. 1) with infra red light. An infra red sensitive imager can be utilized to image the gaming area 110, 128 (in FIG. 1) and these images can potentially be processed using a region growing algorithm. In an alternate embodiment, a region growing algorithm can be performed based on a single channel such as for example grayscale. The definition of the 2-D region or 2-D block can be based on a single channel, for example a grayscale value definition. It is recognised that the chip identity module and the identity module can be combined as one module to assign identity to the generic gaming object.

7. Alternative Embodiment of Chip Identity Module:

With reference to FIG. 1B, a gaming region with RFID chip tracking sensors 105 embedded underneath the betting regions 112 is shown. Currently commercially available RFID based chip tracking systems utilizing RFID embedded casino chips 107 can be utilized as the chip identity module of the system. In this alternate embodiment, a lateral imaging system 106 (in FIG. 1) and chip identity module 520 (in FIG. 5) can be replaced with an RFID chip tracking system. An RFID based system may be desirable for games where multiple betting areas are closely located thus chip stacks can potentially block the view of the lateral imaging system 106 (in FIG. 1) from imaging all chip stacks on the table 128 (in FIG. 1).

In this alternative embodiment, the RFID sensors 105 (in FIG. 1B) would potentially recognize chips 107 (in FIG. 1B) on the wagering regions 112 (in FIG. 1B) and transmit the data representing the identified chips to game tracking software module 514 (FIG. 5).

8. Game Tracking Software Module:

With reference to FIG. 5, a game tracking software module 514 receives input from all other software modules 516, 518, 519, 520, 522 and 524. It can send and receives data from the database 512 and to reporting terminals 510.

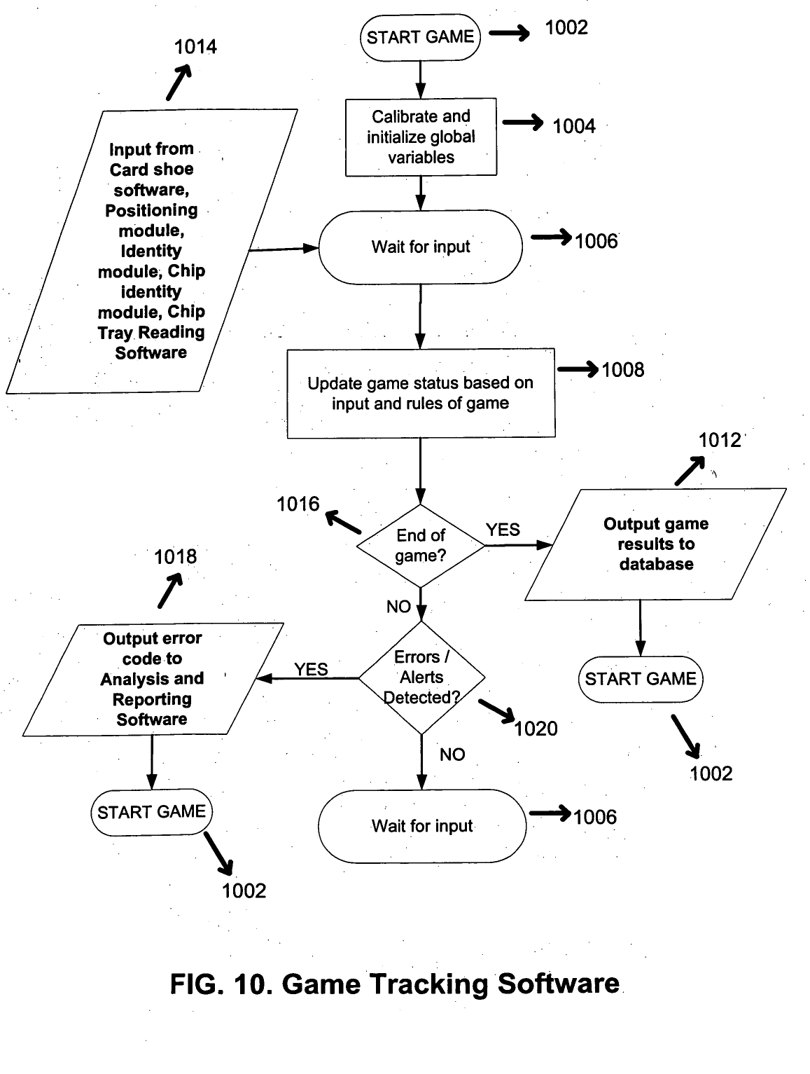

With reference to FIG. 10, in steps 1002 and 1004 the software loads operating parameters into memory and waits for input from other software modules 516, 518, 519, 520, 522 and 524. The game tracking software 514 (in FIG. 5) organizes the input to track the actual game events in real time. In step 1008, disparate events detected by individual software modules 516, 518, 519, 520, 522 and 524 (in FIG. 5) can be interpreted to determine the actual gaming events and to update a current game status. For example, when a dealer withdraws a card from the card shoe and deals the card to a player, in step 1006 the input from the card shoe software 516 (in FIG. 5) can be received indicating the identity of the card dealt. Input from the positioning module 518 (in FIG. 5) and identity module 519 (in FIG. 5) can be received indicative of gaming profiles of recognized gaming objects. Input can be received from the chip identity module 520 (in FIG. 5) indicating chips being wagered in the game.

In step 1008, the game tracking software module 514 (in FIG. 5) can correlate these inputs to associate a dealt card to a player and associated wagers in the game. Detected game events can be checked against the rules of the game to ensure that the game procedures are being followed. The current status of the game at any point in the game can be maintained in memory and can periodically be compared to new input to determine changes and identify game events that may have occurred. Based on new input a status of a game can be updated to reflect potential recent developments. For example, with reference to FIG. 1, a game status can include information about, the wagers 114 or value of chips 116 in the betting areas 112, cards 123 and/or card hands 122 on the game table 128, the history of each card hand 122 with respect to hits/stands/splits/double downs, a player profile associated with a hand 122, a total value of chips in the dealer's chip tray 118, procedure violations detected in a game and other non procedural activities detected on the game table 128.

With reference to FIG. 10, in step 1016 if updated game status reflects the end of the game, gathered data about the game can be transmitted to the database 512 (in FIG. 5) in step 1012 and the method is re-initiated at step 1002. If the game is not over and if there are errors or alerts in the game status, in step 1018 these alerts/errors are transmitted to analysis and reporting software 524 (in FIG. 5).

9. Analysis and Reporting Software Module:

With reference to FIG. 5, an analysis and reporting software module 524 can mine data in the database 512 to provide reports to casino employees. It can be responsible for the end functionality provided to the casino. The module 524 can be configured to perform functions including automated player tracking, including exact handle, duration of play, decisions per hour, player skill level, player proficiency and true house advantage. The module 524 can be configured to automatically track operational efficiency measures such as hands dealt per hour reports, procedure violations, employee efficiency ranks, actual handle for each table and actual house advantage for each table. The module 512 can be configured to provide card counter alerts by examining player playing patterns. It can be configured to automatically detect fraudulent or undesired activities such as shuffle tracking, inconsistent deck penetration by dealers and procedure violations. The module 512 can be configured to provide any combination or type of statistical data by performing data mining on the recorded data in the database 512.

Output, including alerts and player compensation notifications, can be through output devices 510 such as monitors, LCD displays, or PDAs. An output device 510 can be of any type and is not limited to visual displays and can include auditory or other sensory means. The software 524 can potentially be configured to generate any type of report with respect to casino operations.

The software 524 can be configured to accept input from a user interface running on input devices 510. These inputs can include, without limitation, training parameters, configuration commands, dealer identity, table status, and other inputs required to operate the system.

10. Instructional Feedback

With reference to FIG. 1A, a gaming region including a feedback mechanism is shown. Feedback devices 103 located on the game table 128 could provide instructional feedback to the dealer based on data gathered on game events. For example, the decision making process can be removed from the dealer 126. Game events detected in real time could enable determination in real time of the actions that the dealer 126 must take as per game rules. Therefore, a feedback mechanism including for example LEDs installed at the table, can be in place in the gaming area to instruct the dealer to take specific actions such as payout, bust, push and error. Such a feedback mechanism can serve to instruct the dealer on what activities to perform at the table.

11. Player Recognition Features:

Real time biometrics software can be integrated with the overall system. For example, a face recognition software module can be integrated with the overhead and/or lateral imaging systems 102, 106 (in FIG. 1) in order to automatically identify players at the tables. Biometrics software can be purchased from a commercial solution provider or it can be developed internally. This would enable automatic identification of players 120 (in FIG. 1) at the game table 128 (in FIG. 1).

12. Other Embodiments:

The description put forth herein does not attempt to limit the scope and applications of the invention. The system can be extended to other applications relating to casino monitoring and security. The specific algorithms that have been described in the various modules are subject to modification by one skilled in the art. Steps in the algorithms can be performed in a different order or in parallel. The system does not require the presence of all the modules to function. The system may operate and perform a subset of functions using a subset of the modules thus providing a subset of the functionality.

The terms imagers and imaging devices have been used interchangeably in this document. The imagers can have any combination of sensor, lens and/or interface. Possible sensors include, without limitation, CCD sensors, CMOS sensors, line-scan sensors or area-scan sensors. Possible interfaces include, without limitation, 10/100 Ethernet, Gigabit Ethernet, USB, USB 2, FireWire, PAL or NTSC interfaces. For analog interfaces such as NTSC and PAL a processor having a capture card in combination with a frame grabber can be utilized to get digital images or digital video.

The image processing and computer vision algorithms in the software can utilize any type or combination or color spaces or digital file formats. Possible color spaces include, without limitation, RGB, HSL, CMYK, Grayscale and binary color spaces.

The overhead imaging system 102 (in FIG. 1) may be associated with one or more display signs. Display sign(s) can be non-electronic, electronic or digital. Display sign can be an electronic display displaying game related events happening at the table in real time. A display and the housing unit for the overhead imaging devices 208 (in FIG. 2A) may be integrated into a large unit. The overhead imaging system 102 (in FIG. 1) may be located on or near the ceiling above the gaming region.

With respect to FIG. 3, the transparent window 315 can be any other unit designed to direct or allow light from the card face of an offset card 324 to an imager or scanner that can be located in the card shoe system of FIG. 3. A light directing unit may also be a lens or lens assembly. Imaging of the card shoe system of FIG. 3 may be initiated by a triggering means. The triggering means may be hardware based or software based or a combination of both. Hardware triggering means include, without limitation, mechanical, electrical, optical and magnetic triggering means.

To facilitate player profiling, a player identity tracking module may be included with the system. The module can have hardware components to read the identity of the players. These hardware components can include a player identity card and a reader to read an identity card. Identity cards can have a magnetic stripe or barcode. The identity card reader can be a magnetic swipe reader or a standard barcode reader. The player identity card reader can be in the gaming area. A unique identity card assigned to each player can be swiped at the reader when a player begins a play session at a table. Information regarding a player's position can be keyed in by the dealer into an input device placed in the gaming area. Optionally multiple magnetic swipe readers can be built into the table or attached to the table at each player position. Optionally RFID chips embedded into player cards can be utilized to provide the player tracking functionality. In another embodiment of the player identity and position tracking module, biometric systems and software can be used to automatically detect and identity players at a gaming table. Images from a lateral imaging system 106 (in FIG. 1) can optionally be used by the biometric system for identifying players. Biometric systems that can be used include, face recognition technology, eye recognition and hand recognition and fingerprint recognition systems.

To facilitate the tracking of dealers, a dealer identity module may be associated with the system. The module implementation could be similar to the player identity and position tracking module. Optionally, the dealer identity module can be integrated with the player identity and position tracking module. The dealer can optionally either key in her unique identity code at the game table or optionally she can use an identity card and associated reader to register their identity. A biometrics system may be used to facilitate dealer or employee identification.

1. An automatic card shoe apparatus for generating an identity signal indicative of the identity of a playing card selected from a stack of playing cards, the apparatus comprising:
a base;
a compartment coupled to the base for receiving the stack of playing cards;
an actuated mechanism coupled to the compartment for offsetting at least one of the playing cards from the stack of playing cards, the actuated mechanism configured for placing the offset card such that the offset card is retained in an offset stationary position with respect to the card stack;
a position sensor coupled to the actuated mechanism for sensing the presence of the offset stationary card; and
a reader for recording a machine readable indicia positioned on the offset portion of the offset card, the recorded machine readable indicia for use in generating the identity signal.

2. The apparatus according to claim 1 further comprising a control circuit coupled to the actuated mechanism for directing the operation of the actuated mechanism.

3. The apparatus according to claim 2, wherein the position sensor provides an actuation signal to the control circuit, such that the operation of the actuated mechanism is coordinated with the presence of the offset card in the stationary position.

4. The apparatus according to claim 1, wherein the reader is a bar code scanner and the machine readable symbol is a bar code.

5. The apparatus according to claim 1, wherein the reader is an imager for recording an image of the offset portion of the offset card.

6. The apparatus according to claim 5, wherein the machine readable indicia includes the rank of the offset card.

7. The apparatus according to claim 5, wherein the machine readable indicia includes the suite of the offset card.

8. The apparatus according to claim 6, wherein the machine readable indicia is recognized by an optical character recognition algorithm performed on the image.

9. The apparatus according to claim 4, wherein the machine readable indicia on the offset card is printed with ink detectable in a light spectrum selected from the group comprising: visible; ultra violet; and infra red.

10. The apparatus according to claim 5, wherein the machine readable indicia on the offset card is printed with ink detectable in a light spectrum selected from the group comprising: visible; ultra violet; and infra red.

11. A method for generating an identity signal indicative of the identity of a playing card selected from a stack of playing cards, the method comprising the steps of:
offsetting at least one playing card from a stack of playing cards by an actuated mechanism such that the offset card is retained in an offset stationary position with respect to the card stack;
recording a machine readable indicia positioned on the offset portion of the offset card; and
generating the identity signal using the recorded machine readable indicia.

12. The method according to claim 11 further comprising the step of directing the operation of the actuated mechanism by a control circuit.

13. The method according to claim 12 further comprising the step of providing an actuation signal to the control circuit, such that the operation of the actuated mechanism is coordinated with the presence of the offset card in the stationary position.

14. The method according to claim 11, wherein the reader is a bar code scanner and the machine readable symbol is a bar code.

15. The method according to claim 11, wherein the reader is an imager for recording an image of the offset portion of the offset card.

16. The method according to claim 15, wherein the machine readable indicia includes the rank of the offset card.

17. The method according to claim 15, wherein the machine readable indicia includes the suite of the offset card.

18. The method according to claim 16, wherein the machine readable indicia is recognized by an optical character recognition algorithm performed on the image.

19. The method according to claim 14, wherein the machine readable indicia on the offset card is printed with ink detectable in a light spectrum selected from the group comprising: visible; ultra violet; and infra red.

20. The method according to claim 15, wherein the machine readable indicia on the offset card is printed with ink detectable in a light spectrum selected from the group comprising: visible; ultra violet; and infra red.

21. The method according to claim 15, wherein the machine readable indicia is a unique identifier for each of the cards in the stack of playing cards.
